(19) United States
(12) Patent Application Publication
(10) Pub. No.: US 2015/0147477 A1
(43) Pub. Date: May 28, 2015

(54) GREASE & METHOD FOR APPLYING GREASE

(71) Applicant: AKTIEBOLAGET SKF, Göteborg (SE)

(72) Inventors: Ingemar Strandell, Savedalen (SE); Frank Fiddelaers, Gorinchem (NL)

(21) Appl. No.: 14/370,326

(22) PCT Filed: Dec. 17, 2012
(86) PCT No.: PCT/SE2012/000202

§ 371 Date: Jul. 2, 2014

(30) Foreign Application Priority Data
Jan. 2, 2012 (SE) 1200009-7

(51) Int. Cl. C10M 169/06; B05D 5/08; B05D 1/36

(52) U.S. Cl. CPC C10M 169/06; B05D 1/36; B05D 5/08
USPC 427/407.1; 508/451; 508/459; 508/552; 508/579; 508/591

(57) ABSTRACT

A two-component grease package for lubricating a mechanism, wherein the grease package includes a first component comprising a thickener, and a second component comprising a fluid lubricant, whereby the two-component grease is obtained by mixing together the first and the second component.

### CROSS REFERENCE TO RELATED APPLICATION

This is a National Stage application claiming the benefit of International Application Number PCT/SE2012/000202 filed on 17 Dec. 2012, which claims the benefit of Sweden Patent Application 1200009-7 filed on 2 Jan. 2012, both of which are incorporated herein by reference in their entireties.

### TECHNICAL FIELD

The present invention concerns grease for lubricating a mechanism, and a method for applying such grease to a mechanism.

### BACKGROUND OF THE INVENTION

The term grease, in the context of lubrication, is used to describe a semi-solid lubricant consisting of a thickener, typically a soap, emulsified with mineral or vegetable oil and/or other fluid lubricant. Grease possesses a high initial viscosity, which upon the application of shear, drops to give the effect of oil lubrication of approximately the same viscosity as the base oil (or fluid lubricant) used in the grease. Greases are applied to mechanisms that can only be lubricated infrequently and where a lubricating oil would not stay in position.

Grease also protects the mechanisms that it lubricates against corrosion and wear, it helps to dissipate heat, seal out solid and liquid contamination, and reduces noise. Adequate lubrication allows for smooth continuous operation of equipment, with only mild wear, and without excessive stresses or seizures at components such as bearings. When lubrication fails, components can rub destructively over each other, causing damage, heat, and failure. Lubrication failure can be caused by insufficient lubricant quantity or viscosity, deterioration due to prolonged service without replenishment, excessive temperatures, contamination with foreign matter, the use of an incorrect grease for a particular application and/or over-lubricating.

To ensure that a mechanism is correctly lubricated, the grease used has to be precisely selected for the particular application and applied in the right amount, at the right frequency and to the right place(s) in the mechanism. Factors influencing the choice of grease for a bearing application for example, include the bearing's rotational speed, service temperature range, running noise requirements, re-lubrication intervals, sealing, starting torque, load and running conditions and environmental influences.

Over time, the grease may leak, evapourate and/or harden. Oil may be depleted from the grease leaving a thick waxy substance with little or no ability to lubricate. New grease may be applied, using a grease gun or pump for example which applies the grease to the part(s) being lubricated under pressure, forcing the grease into the spaces in the part(s). However, to prevent premature wear and damage, manufacturers recommend that old grease is removed and replaced with new grease on a periodic basis, which can be a complex and time consuming process since it often requires equipment to be dismantled and carefully cleaned.

### SUMMARY OF THE INVENTION

An object of the invention is to overcome or ameliorate at least one of the disadvantages of the prior art, or to provide a useful alternative.

At least one of these objects is achieved by a two-component grease package for lubricating a mechanism, which comprises a first component comprising a thickener, and a second component comprising a fluid lubricant, whereby the two-component grease is obtained by mixing together the first and second components.

The first component comprising a thickener is selected depending on the application in which the mechanism will be used, constitutes a carrier for fluid lubricant. The first component may namely be applied to at least a part of a mechanism that is to be lubricated, such as on cage bars of a bearing or inside the bearing itself, such as on an inner or outer ring thereof. The second component comprising a liquid lubricant that is also selected depending on the application in which the mechanism will be used, may then be applied to at least a part of the mechanism. When the first component is mixed with the second component the thickener partially dissolves in the liquid lubricant and combines to form grease having the optimum composition for the application in which the mechanism will be used.

Factors influencing the choice of the thickener and fluid lubricant for a bearing application for example, may include the bearing's rotational speed, service temperature range, running noise requirements, re-lubrication intervals, sealing, starting torque, load and running conditions and environmental influences.

If/when the first component comprising a thickener and/or the second component comprising a fluid lubricant become(s) depleted, a first component and/or second component may be applied to the mechanism to re-lubricate the mechanism. More of the first and/or second component may namely be added periodically and/or if/when re-lubrication is needed. It should be noted that the first component and/or second component which is/are added to re-lubricate the mechanism need not necessarily be of the same composition as the first component and/or second component which was/were previously applied to lubricate the mechanism. The subsequently added first component and/or second component may for example comprise only that part of the previously applied first component and/or second component which has been consumed during the use of the mechanism. Only small amounts of liquid lubricant may for example be required for re-lubrication of the mechanism.

Such a two-component grease package provides several advantages over greases according to the prior art. Re-lubrication of a mechanism is namely much simpler since old grease does not have to be removed from a mechanism, a plurality of different greases for different applications does not have to be kept in stock by a grease manufacturer and the amount of waste grease is reduced since the grease's thickener is re-used. Furthermore, such a two-component grease package increases the possibilities for improved automated and application-tailored lubrication and re-lubrication.

The expression “package” is intended to mean that the first component and the second component of the two-component grease are provided as a wrapped/sealed unit, or that the first component and the second component are provided as related items that are intended to be used together, even if not provided as a wrapped/sealed unit.

According to an embodiment of the invention the fluid lubricant comprises at least one of the following: mineral oil, such as synthetic oil, vegetable oil, a polyalphaolefin, an ester, a polyether.

According to another embodiment of the invention the thickener comprises at least one of the following: a polymeric thickener, polypropylene, polyethylene, polyalkylene glycol, polyethylene glycol, polyolefin (or “polyalkene”) phenol, lanolin, lanoline polyethylene glycol, polyoxyethylene lanolin, silicon oil, ionic soap, urea soap, metal organic soap.

The selection of the type of thickener is determined by the application. A soap may for example include calcium stearate, sodium stearate, lithium stearate, as well as mixtures of these components. A fatty acid derivative other than a stearate, such as lithium 12-hydroxystearate, may also be used as a thickener. The nature of the thickener influences the temperature resistance, water resistance, and chemical stability of the resulting grease. The thickener may also comprise tar, graphite or mica, which also increase the durability of the grease.

According to a further embodiment of the invention the thickener comprises at least one high molecular weight component and at least one low molecular component where the high molecular weight component and/or the low molecular component comprises at least one of the following: a polymeric thickener, polypropylene, polyethylene, polyalkylene glycol, polyethylene glycol, polyolefin phenol, lanolin, lanoline polyethylene glycol, polyoxyethylene lanolin, silicon oil.

The molecular weight of polymer molecules determines the physical properties of the polymer, for example the temperatures at which transitions from liquids to solids occur, and mechanical properties such as the stiffness, strength, viscoelasticity, toughness and viscosity of the polymer. By combining thickener components of high and low molecular weight, physical and mechanical properties of the thickener can be optimized for a particular application.

According to an embodiment of the invention the first component and/or the second component comprises at least one of the following: a tackifier, an elastomer, an anti-wear additive, an anti-corrosion additive, an EP additive, an anti-oxidant. Some greases are labeled “EP”, which indicates “extreme pressure”. Under high pressure or shock loading, normal grease can be compressed to the extent that the greased parts come into physical contact, causing friction and wear. EP grease contains solid lubricants, usually graphite and/or molybdenum disulfide, to provide protection under heavy loadings. The solid lubricants bond to the surface of metal components, and prevent metal-to-metal contact and the resulting friction and wear when the lubricant film gets too thin.

It should be noted that the first component comprising a thickener and/or the second component comprising a fluid lubricant may comprise at least one additive. Teflon may for example be added to improve the lubricating properties of the resulting grease. Glycerol and sorbitan esters may be added to grease that is intended to be used in low temperature conditions. Copper may be added to grease intended for a high pressure applications.

According to an embodiment of the invention the two-component grease package comprises a thickener comprising at least one polyolefin component, for example comprising polyethylene or polypropylene or mixtures of these substances, at least one fluid lubricant component such as mineral oil, vegetable oil, synthetic oil-like polyalphaolefins, esters or polyethers, and at least one additive component which is selected from the group antioxidants, corrosion inhibitors, anti-wear agents or extreme pressure/load carrying capacity increasing additives. The content of the thickener component(s) may be between 5% and 30% by weight, preferably between 9 and 15% by weight, the content of the fluid lubricant(s) is between 60% and 90% by weight and the additive component(s) by weight between 0.2 and 15%, preferably between 1 and 8% by weight.

According to an embodiment of the invention the two-component grease package comprises a high molecular weight component and a low molecular weight component. For example, the thickener may comprise a mixture of a) a (co- or homo-)polymer of propylene with a weight average molecular weight greater than 200,000 and (b) a (co- or homo-)polymer of propylene with a weight average molecular weight less than 100,000. The ratio between the high molecular weight component and the low molecular weight component may be 1:40-1:5, preferably 1:25-1:15, more preferably 1:19. The low molecular weight component may be a polypropylene homopolymer. The low molecular weight component may have an average molecular weight between 50,000 and 100,000 with a melt flow rate (ASTM D-1238) of 500-1000, preferably 750-850. The high molecular weight component may be a polypropylene homopolymer or a propylene/ethylene-copolymer. The high molecular weight component may have an average molecular weight of 200,000-250,000 and a melt flow rate (ASTM D-1238) of 1.5-15, preferably 1.5-7.

According to another embodiment of the invention the two-component grease package comprises a mineral oil, at least one of the following: a thickening agent, oil-soluble polypropylene, oil-soluble propylene or mineral, metal soaps (soap-salt thickener), oil-soluble polypropylene, oil-soluble propylene or amorphous polyolefine polymers or semicrystalline polyolefine polymers e.g. isotactic or atactic polyolefin polymers.

Esters can effect solubility and boost oil-solubility of additives and thickening agents like polymers. Esters may be derived from carboxylic acids, branched, unbranched, straight or with cyclic alkyl group, aryl, alkaryl or aralkyl group with 1-30 carbons, cyclic fatty esters, alkyl esters, saturated and unsaturated esters, diesters (from dicarboxylic organic compounds), disebacic acide esters, polyol esters, synthetic esters, phthalate esters, carboxylic acid esters. Alkylated napthlenes may be used as a synthetic fluid lubricant.

According to an embodiment of the invention the two-component grease package may comprise a paraffin based wax of a carbon chain length up to C40, either in pure form or in mixtures of different alkenes, or mixed with other polyolefin polymers (polyethylene) or ester waxes like cetyl myristoleate esters or cetyl palmitate esters. Waxes are natural, organic compounds that characteristically consist of long alkyl chains.

According to an embodiment of the invention the mechanism is at least part of a machine component, such as shafts, couplings, keys, splines, gears, fasteners, springs, seals, belts, clutches, brakes and chains. According to an embodiment of the invention the mechanism is at least part of a bearing component, such as a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength.

The two-component grease package according to the present invention is particularly, but not exclusively, suitable for use with large size machine and bearing components, and components used in high speed or low temperature applications.

The present invention also concerns a method for applying grease to a mechanism. The method comprises the steps of applying a first component comprising a thickener to the mechanism and applying a second component comprising a fluid lubricant to the mechanism, whereby the grease is obtained by mixing the first and second components. It should be noted that it is preferable to apply the first component comprising a thickener to the mechanism before applying a second component comprising a fluid lubricant, however the first and second component need not necessarily be applied in that order but the second component may be applied before the first component, or the first and second components may be applied simultaneously.

According to an embodiment of the invention the method comprises the step of applying the first component to the mechanism prior to transporting the mechanism to its operation site. A client/user may therefore receive a mechanism to which the first component of the two-component grease package has already been applied. The client/user will then apply the second component of the two-component grease package whereby grease of the optimum composition for the client's/user's application will be obtained. Furthermore, the thickener may provide corrosion protection during the transportation of the mechanism.

According to another embodiment of the invention the method comprises the step of re-applying the first and/or second component to the mechanism to re-lubricate the mechanism. A first component and/or second component having a different chemical composition and/or different physical and/or mechanical properties than the first component and/or second component which was/were previously applied may be more suitable as re-lubrication.

According to an embodiment of the invention the lubrication may be checked to determine whether re-lubrication is needed and/or exactly what type of re-lubrication is needed.

Further embodiments of the method according to the present invention are recited in the dependent method claims.

### BRIEF DESCRIPTION OF THE DRAWINGS

The present invention will hereinafter be further explained by means of non-limiting examples with reference to the appended figures where;

FIG. 1 shows a bearing lubricated with two-component grease according to an according to an embodiment of the invention, and

FIG. 2 shows the steps of a method for applying grease to a mechanism according to an embodiment of the invention.

It should be noted that the drawings have not been drawn to scale and that the dimensions of certain features have been exaggerated for the sake of clarity.

### DETAILED DESCRIPTION OF EMBODIMENTS

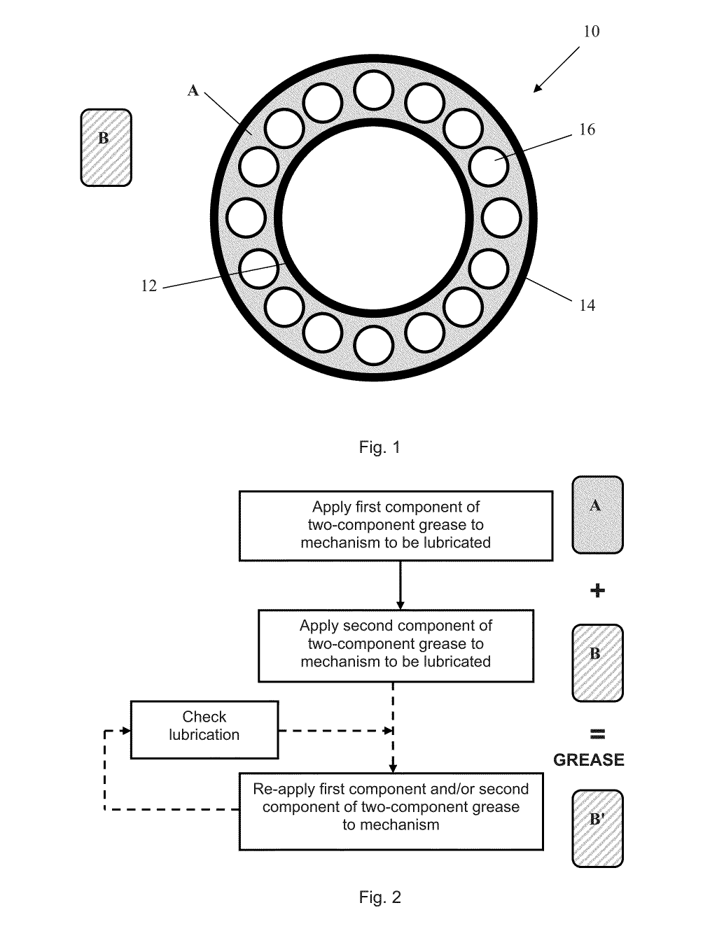

FIG. 1 schematically shows an example of a bearing component 10, namely a rolling element bearing, that may range in size from 10 mm in diameter to a few metres in diameter and have a load-carrying capacity from a few tens of grams to many thousands of tonnes. The bearing component 10 may namely be of any size and have any load-carrying capacity. The bearing component 10 has an inner ring 12, an outer ring 14 and a set of rolling elements 16.

Grease must be provided between the rolling elements 16 and the inner ring 12 and outer ring 14 to lubricate the rolling element bearing 10. A two-component grease package is therefore selected depending on the bearing's rotational speed, service temperature range, running noise requirements, re-lubrication intervals, sealing, starting torque and/or environmental influences. A first component A comprising a thickener, such as at least one of the following: a polymeric thickener, polypropylene, polyethylene, polyalkylene glycol, polyethylene glycol, polyolefin phenol, lanolin, lanoline polyethylene glycol, polyoxyethylene lanolin, silicon oil, ionic soap, urea soap, metal organic soap is then applied to at least one part of volume between the rolling elements 16 and the inner ring 12 and outer ring 14 such as on at least a part of the inner ring 12 and outer ring 14. The thickener may for example comprise polypropylene having both molecules of a high molecular weight and molecules of a low molecular weight. This first component A may be applied to the rolling element bearing 10 before it is transported to its operation site, i.e. before it is transported to a client/user and/or installed/mounted for operation.

The second component B of the two-component grease package comprising a fluid lubricant comprising at least one of the following: mineral oil, synthetic oil and/or vegetable oil, may then be applied by the client/user before the rolling element bearing 10 is put into use. Grease is thereby obtained by mixing together the first and second components A and B.

According to an embodiment of the invention the resulting grease (A+B) comprises 60-90% of the second component B comprising a liquid lubricant. For example, the resulting grease comprises 85% liquid lubricant and 15% thickener. The resulting grease (A+B) may also comprise at least one of the following: a tackifier, an elastomer, an anti-wear additive, an anti-corrosion additive, an EP additive, an anti-oxidant.

The first component A and/or the second component B may be applied to a single point, area or volume of a mechanism or to a plurality of points, areas or volumes. The first component A and/or the second component B may be applied manually or using an automatic lubricator. The first component A and/or the second component B may for example be sprayed onto at least one part of a mechanism.

FIG. 2 shows the steps of a method for applying grease to a mechanism, such as at least part of a machine component or a bearing component. The method comprises the steps of applying a first component A comprising a thickener to the mechanism and applying a second component B comprising a fluid lubricant whereby the grease is obtained by mixing the first and second components A and B. According to an embodiment of the invention, the first component A comprising thickener may be applied to the mechanism prior to transporting the mechanism to its operation site.

According to another embodiment of the invention a first component A′ and/or a second component B′ comprising only that part of a previously applied first component A and/or second component B which have been consumed during the use of the mechanism may be re-applied to re-lubricate the mechanism if/when needed or periodically. In the embodiment illustrated in FIG. 2 only a second component B′ comprising that part of a previously applied second component B which has been consumed during the use of the mechanism, mineral oil for example, is re-applied to re-lubricate the mechanism. The lubrication may optionally be checked to determine whether re-lubrication is needed and/or exactly what type of re-lubrication is needed and re-lubricated accordingly.

Further modifications of the invention within the scope of the claims will be apparent to a skilled person.

1. A two-component grease package for lubricating a mechanism, wherein the two-component grease package comprises a first component comprising a thickener, and a second component comprising a fluid lubricant, whereby the two-component grease is obtained by mixing together the first component and second component.

2. The two-component grease package according to claim 1, wherein the fluid lubricant comprises at least one of the following: mineral oil, synthetic oil, vegetable oil, a polyalphaolefin, an ester, and a polyether.

3. The two-component grease package according to claim 1, wherein the thickener comprises at least one of the following: a polymeric thickener, a polyolefin, polypropylene, polyethylene, polyalkylene glycol, polyethylene glycol, polyolefin phenol, lanolin, lanoline polyethylene glycol, polyoxyethylene lanolin, silicon oil, ionic soap, urea soap, and metal organic soap.

4. The two-component grease package according to claim 1, wherein the thickener comprises at least one high molecular weight component and at least one low molecular component.

5. The two-component grease package according to claim 4, wherein the ratio of the at least one of high molecular weight component to the at least one low molecular component is between 1:40 and 1:5.

6. The two-component grease package according to claim 4, wherein at least one of the thickener high molecular weight component and the low molecular component comprises at least one of the following: a polymeric thickener, polypropylene, polyethylene, polyalkylene glycol, polyethylene glycol, polyolefin phenol, lanolin, lanoline polyethylene glycol, polyoxyethylene lanolin, and silicon oil.

7. The two-component grease package according to claim 1, wherein the two-component grease comprises at least one of the following additives: a tackifier, an elastomer, an anti-wear additive, an anti-corrosion additive, an EP additive, and an anti-oxidant.

8. The two-component grease package according to claim 1, wherein the mechanism is at least part of a machine component.

9. The two-component grease package according to claim 1, wherein the mechanism is at least part of a bearing component.

10. The two-component grease package according to claim 1, wherein the two-component grease comprises between 3 and 30 weight-% thickener and between 60 and 97 weight-% fluid lubricant.

11. The two-component grease package according to claim 7, wherein the two-component grease comprises between 0.2 and 15 weight-% of the at least one additive.

12. A method for applying grease to a mechanism, the method further comprising steps of applying a first component including a thickener to the mechanism and applying a second component (B) including a fluid lubricant to the mechanism, whereby the grease is obtained by mixing the first component and the second component.

13. The method according to claim 12, the method further comprising a step of applying the first component to the mechanism prior to transporting the mechanism to its operation site.

14. The method according to claim 12, the method further comprising a step of re-applying at least one of the first component and the second component to the mechanism to re-lubricate the mechanism.

15. The method according to claim 12, the method further comprising a step of re-applying at least one of only that part of the first component and only that part of the second component to the mechanism which has been consumed to re-lubricate the mechanism (10).

16. The method according to claim 12, wherein the fluid lubricant comprises at least one of the following: mineral oil, synthetic oil, vegetable oil, a polyalphaolefin, an ester, a polyether.

17. The method according to claim 12, wherein the thickener comprises at least one of the following: a polymeric thickener, polypropylene, polyethylene, polyalkylene glycol, polyethylene glycol, polyolefin phenol, lanolin, lanoline polyethylene glycol, polyoxyethylene lanolin, silicon oil, ionic soap, urea soap, and metal organic soap.

18. The method according to claim 12, wherein the thickener comprises at least one high molecular weight component and at least one low molecular component.

19. The method according to claim 18, wherein the ratio of the at least one high molecular weight component to the at least one low molecular component is between 1:40 and 1:5.

20. The method according to claim 18, wherein at least one of the thickener high molecular weight component and the low molecular component comprises at least one of the following: a polymeric thickener, polypropylene, polyethylene, polyalkylene glycol, polyethylene glycol, polyolefin phenol, lanolin, lanoline polyethylene glycol, polyoxyethylene lanolin, and silicon oil.

21. The method according to claim 12, wherein at least one of the first component and the second component comprises at least one of the following: a tackifier, an elastomer, an anti-wear additive, an anti-corrosion additive, an EP additive, and an anti-oxidant.

22. The method according to claim 12, wherein the grease comprises between 3 and 30 weight-% thickener and between 60 and 97 weight-% fluid lubricant.

23. The method according to claim 12, wherein the grease comprises between 0.2 and 15 weight-% of the at least one additive.

24. The method according to claim 12, wherein the mechanism is at least part of a machine component.

25. The method according to claim 12, wherein the mechanism is at least part of a bearing component.
